(19) United States
(12) Patent Application Publication
(10) Pub. No.: US 2017/0169509 A1
(43) Pub. Date: Jun. 15, 2017

(54) DYNAMIC RISK ACCOMMODATING INVESTMENT LENDING

(71) Applicant: The Bank of Kaukauna, Kaukauna, WI (US)

(72) Inventor: John J. Brogan, Kaukauna, WI (US)

(21) Appl. No.: 14/967,796

(22) Filed: Dec. 14, 2015

(51) Int. Cl. G06Q 40/02

(52) U.S. Cl. CPC G06Q 40/025

(57) ABSTRACT

A dynamic lending system may include a computing device in communication with a network. The computing device may include a computer readable data storage medium having data structures stored thereon for facilitating and dynamically allocating peer-to-peer loan transactions. The data structures may include a borrower profile module configured to receive borrower characteristics and assign a risk value, a lender risk/return parameter module configured to establish a risk/return level of a lender, a transaction module configured to facilitate investment by lenders and loans to borrowers, and an allocation module configured to allocate loans or portions of loans to investors based on the risk value of loans and the risk/return level of the lender. A method for dynamically facilitating peer-to-peer lending may also be provided.

### FIELD OF THE INVENTION

The present disclosure relates to systems and methods for facilitating investment and lending. In particular, the present disclosure includes discussion of a computer-implemented system for facilitating peer-to-peer lending where the borrowers may be assessed for risk and the lenders may select the risk and corresponding return they are interested in obtaining. Still more particularly, the system may dynamically reallocate funds based on dynamically changing risk of borrowers and investors so as to maintain or rebalance the risk profile of each investor.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Unsecured loans, which involve borrowing money without putting forth collateral, are a common way for individuals or companies to quickly raise cash and/or account for ebbs in flows on the demand for cash. In the case of an unsecured loan from a traditional financial institution such as a bank, loans are provided to borrowers based on the borrower's risk. Higher risk borrowers are charged a higher interest rate than lower risk borrowers. In the case of default on the loan, the bank absorbs the loss while guaranteeing an interest rate return to its investors. That is, lenders who have placed funds in their savings accounts, are guaranteed a particular interest rate on that money. When a borrower from the bank defaults on the loan, the interest rate on the lenders savings account is not changed as a result. For these reasons, placing money into a savings account provides a great deal of security for those deposits, but that security results in a lower rate of return. As such, depositors may not experience a significant return on investment.

Other non-traditional lending/borrowing schemes have emerged along with the internet. That is, peer-to-peer lending organizations have become relatively common. For example, organizations such as Prosper and Lending Club have become two relatively prominent peer-to-peer lending organizations in the United States of America. In the case of peer-to-peer lending, loans are made from one person or entity directly to another person or entity. The lending organization is involved for purposes of connecting lenders to borrowers and for facilitating the transaction. The lending organization is generally a for profit organization that charges borrowers a one-time fee upon funding a loan and charges lenders a loan servicing fee. The lenders may select the borrowers that they are interested in investing in based on the risks of those borrowers and the corresponding interest rates that those borrowers will pay.

As may be appreciated, given the current peer-to-peer lending systems that are available, a lender using this system may have to constantly review her debt portfolio to ensure that it is consistent with her investment goals. That is, loans are not static. Loans have terms, interest rates that may be constant or that may vary, and from time to time, borrowers may repay a loan in full or may seek additional funds, etc. Still further, where a lender is borrowing funds to more than one borrower in a peer-to-peer setting, changing borrowers may affect the debt portfolio of the lender.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a schematic diagram of a dynamic lending system, according to one or more embodiments.

FIG. 2 is a diagram showing several modules of the lending system, according to one or more embodiments.

FIG. 3 is a table showing a plurality of loans in the system with particular risk values, according to one or more embodiments.

FIG. 4 is a table showing allocation of portions of the loans of FIG. 3 to investor A, according to one or more embodiments.

FIG. 5 is a table showing allocation of portions of the loans of FIG. 3 to investor B, according to one or more embodiments.

FIG. 6 is a table showing allocation of portions of the loans of FIG. 3 to investor C, according to one or more embodiments.

FIG. 7A includes a flow chart of a portion of a process that may be performed by the system of FIGS. 1 and 2, according to one or more embodiments.

FIG. 7B includes a flow chart of processes continuing from FIG. 7A, according to one or more embodiments.

### DETAILED DESCRIPTION

The present application, in some embodiments, relates to a dynamic peer-to-peer lending system. That is, in contrast to current peer-to-peer lending systems, the present system may allow a lender to define one or more risk parameters that may, in turn, define the debt portfolio of the lender. At the beginning of a lender's use of the system and from time to time, the system may dynamically fill, adjust, or rebalance the debt portfolio of the lender to bring the portfolio into alignment with the pre-defined or dynamic risk parameter(s). As the intermediary, the system may have access to existing loans, new borrowers, and information about ever changing risk characteristics of borrowers. As such, the system may be able to reallocate risk in a manner that effectively targets the desired risk profile of the lender. In contrast to lenders attempting to manage their debt portfolio using current peer-to-peer lending systems, the present system may perform rebalances automatically and it may do so by reallocating amongst existing loans and it may rely on ever changing information about the borrowers for those loans. This provides, not only automation, but a method of debt management not presently available to lenders who may only have access to new loans to supplement their existing portfolio.

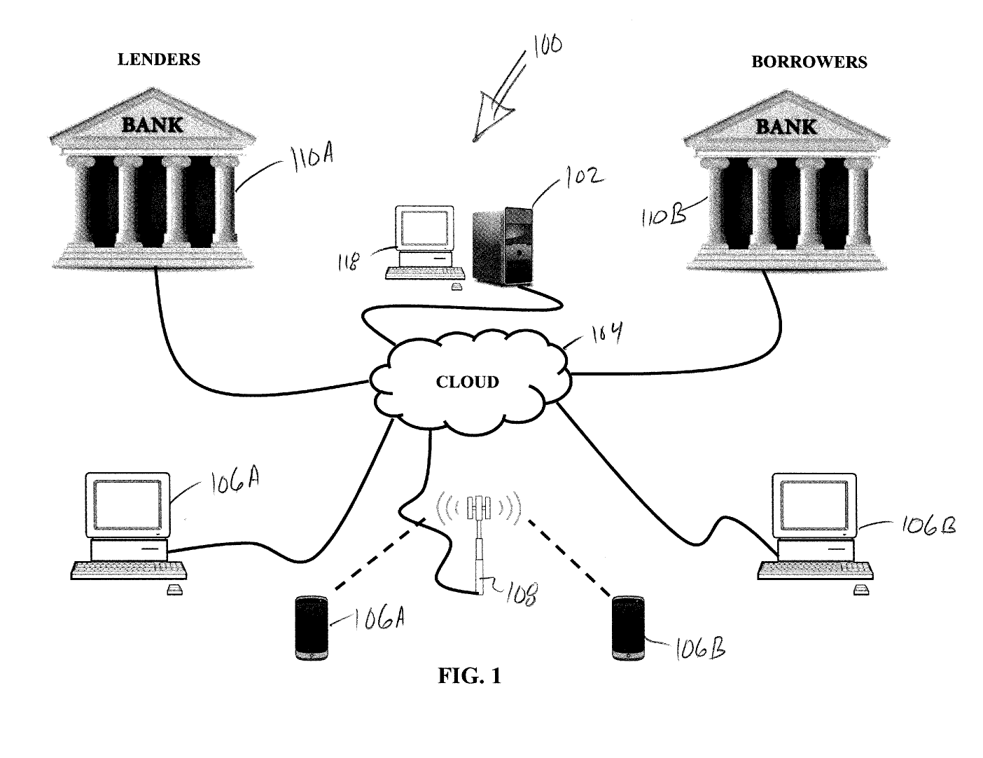

Referring to FIG. 1, the system 100 may include a server 102 in communication with a network 104 such as a wide area network or other network configured for supporting cloud-based computing. In some embodiments, the server may be in communication with the Internet, for example. The system may be accessible via the network or cloud via user computing devices 106 such as personal computers, laptops, notepad-type computers, phones, smartphones, PDA's, and the like. In the case of smartphones or other phones, the phones may access the system through a cellular telephone network 108 as shown or via a WiFi network. In addition to user computing devices, the system may be accessible by one or more financial institutions 110 such that a user may perform financial transactions with the system and provide funds or withdraw funds from the system as the case may be. In some embodiments, the user computing devices 106 and financial institutions 110 may be categorized into lender devices 106A and lender financial institutions 110A and borrower devices 106B and borrower financial institutions 110B. As may be appreciated, the lender and the borrower may rely on the same or different financial institution for managing and/or holding his or her funds.

The financial institutions 110 shown may include banks, credit unions, or other financial institutions where a lender or a borrower may keep his or her funds in a relatively liquid form. In some embodiments, the financial institution 110 may be the institution sponsoring a credit card, for example. In still other embodiments, the institution 110 may be a community bank, or example. Still other examples of financial institutions 110 may be included. The financial institution may be any financial institution 110 that a lender, for example, could direct to supply funds to the system for the purpose of funding a loan. In addition the financial institution 110 may be any financial institution 110 that a borrower, for example, may use to hold loan funds for later use when a loan is received.

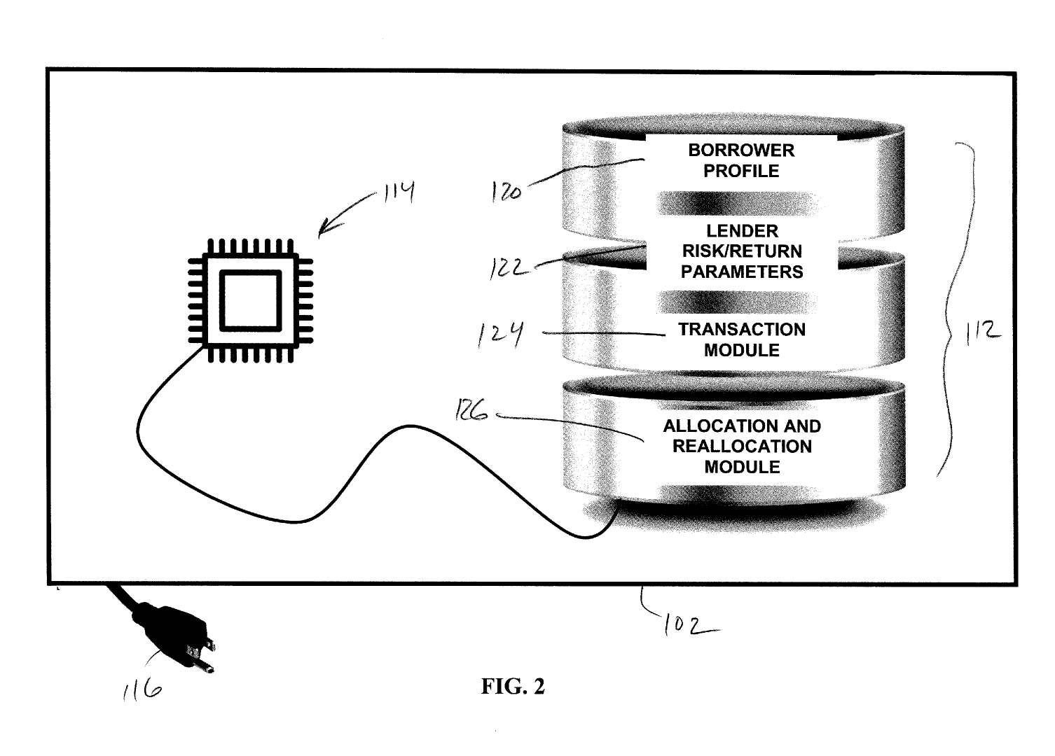

Referring now to FIG. 2, the server 102 may be a computer system having a computer readable storage medium 112 with program instructions stored thereon for performing particular methods. The server 102 may also include a processor 114 for accessing the instructions and performing selected functions based on user input and stored instructions. As shown, the server 102 may include a power source 116 such as a power plug and/or a battery system or battery backup system. The server 102 may also include inputs and outputs including a backend access system 118 including a monitor, mouse, keyboard, and/or other direct access system. In addition, the server 102 may be in communication with the network 104 such that users may access the server 102 over the network 104 and interact with a series of interfaces and potentially perform a transaction.

The computer readable storage medium 112 or special purpose chip on the server 102, may include a series of modules particularly configured for performing particular functions. The modules may include hardware, software, or a combination of hardware and software particularly configured to perform a particular function or an array or series of functions. In some embodiments, the server may include a borrower profile module 120, a lenders' risk/return parameter module 122, a transaction module 124, and a loan allocation and reallocation module 126. Each of these modules are discussed in more detail below.

The borrower profile module 120 may include computer-implemented instructions for supplying a borrower profile interface, receiving borrower input from the interface, and storing the borrower profile information. The borrower profile interface may include a series of fields available to borrowers to allow borrowers to establish a profile that may be used by lenders and/or the system 100 to qualify borrowers for loans and loan amounts and assess and/or assign a risk value to a loan. For example, the interface may include fields reflecting characteristics of the borrower and details regarding the requested loan. The characteristics of the borrower may include information such as credit score, age, sex and the like. Details regarding the requested loan may include information such as size of loan, type of loan, purpose of loan, type of business, desired term of loan, desired interest rate and payment periods, for example. Still other characteristics of the borrower may be included such as citizenship, location information such as city and/or state, or other information that may be relevant to a lender or the system for assessing whether to make a loan to the borrower. Still other characteristics of the borrower and other details of the loan may be provided. The system may rely on this information to establish an initial risk value. For example, a risk scale of 1 to 10 may be used and a low risk borrower may have a risk value of 1 and a high risk borrower may have a risk value of 10. In some embodiments, due to the lack of history with new borrowers, the system may rely solely or heavily on the credit score to establish and initial risk value. For example, and depending on the credit score system used, a credit score of 800 may correspond to a profile value of 1 or 2 and a credit score of 350 may correspond to a profile value of 9 or 10.

It is to be appreciated that the system 100 may monitor borrower conduct within the system and may adjust the borrowers risk value from loan to loan and from time to time. For example, where a borrower with a high risk value develops a history within the system of making consistent payments on a loan or where a loan is approaching the end of its term or the borrower otherwise acts in a manner that causes an increased confidence in the borrower, the borrower of that loan may have their risk value reduced. In contrast, where a low risk borrower misses a payment, defaults on a loan, takes out a loan with a significantly large value or acts in a manner to cause a loss of confidence in the borrower, the borrower's risk value may be increased. As will be discussed in more detail below, the system may be designed to accommodate such variation and adjustment of borrower risk values such that the desired risk and return of a lender is continually accommodated.

The lenders' risk parameter module 122 may include computer-implemented instructions for supplying a risk/return parameters interface, receiving input from the interface, and storing lenders risk/return parameters. The interface may include a series of fields available to lenders to allow lenders to establish the level of risk they are interested in taking in conjunction with an anticipated return on their investment. In some embodiments, the lenders' risk parameter module may be relatively simple and may allow a lender to choose an amount of investment, a risk value, and an associated rate or return. For example, the system may allow the lender to select a risk level or a risk level range from risk values ranching from 1 to 10, for example, where 1 is low risk and 10 is high risk. The system may, thus, allocate loans, or portions thereof, to the lender to collectively provide the selected risk and corresponding rate of return and may adjust the loans allocated to the lender based on changing risk values of borrowers. In some embodiments, the lender may establish more than one risk profile such that particular investments of the investor may be associated with particular profiles.

In other embodiments, the lenders' risk parameter module 122 may be configured to assist the lender in establishing an amount to invest or an appropriate risk and rate of return. For example, the system 100 may have input fields for collecting information about the lender such as income, age, job type, other investment amounts and types, cash flow questions, and the like. Still other characteristics of the lender may be collected and used to make a suggestion or recommendation as to the level of risk the lender may consider. In some embodiments, for example, the closer a lender is to retirement age, the lower the risk value the system 100 may recommend and in contrast, the further a person is from retirement age, the higher the risk value the system 100 may recommend. Still other rules of thumb may be used by the system 100 to help a lender determine what level of risk they are interested in.

In still other embodiments, the system 100 may allow the lender to make selections of borrower characteristics, loan types, or loan amounts that they are interested in to help establish the risk profile. For example, if a lender is interested in a high risk, high rate of return, but is also interested in attempting to control the basis for that risk, the lender may be provided with particular borrower characteristics to choose from such that they may tailor the basis for their risk.

The transaction module 124 may include computer-implemented instructions for supplying interfaces to borrowers and lenders to complete their respective transactions. For example, the transaction module may include a lenders' investment interface for receiving investment payments from investors. The lenders' investment interface may include an investment amount and a selection option for associating a particular risk profile with the investment. That is, where the investor has more than one risk profile, the investor may select which profile the investment should be associated with. The lenders' investment interface may include transaction features for collecting the investment from the investor. The transaction features may include features allowing for identification of a bank, credit or debit card, line of credit, or other financial institution 110A or mechanism for fulfilling an investment commitment.

In some embodiments, the lenders' investment interface may be provided in conjunction with the lenders' risk parameter module 122. For example, where the lender is new to the system and has not established a risk profile, the lender may provide risk profile information while also making an investment.

With respect to borrowers, the transaction module 124 may include a borrower's loan interface for borrowers to take out loans. The borrower's loan interface may allow a borrower to input the amount of the loan they are interested in taking out. The borrower's loan interface may work in conjunction with the borrower profile module to assure that the borrower qualifies for the loan and the loan amount and to associate the loan with corresponding risk values and interest rates. The borrower's loan interface may include transaction features for distributing loan funds to the borrower. The transaction features may include features allowing for identification of a bank, credit or debit card account, line of credit, or other financial institution 110B or mechanism for receiving the loan funds and making the loan funds available to the borrower. In some embodiments, for example, borrowers may be provided with lines of credit with credit limits and borrowers may have ready access to withdrawing funds by using a credit card or other mechanism for accessing funds.

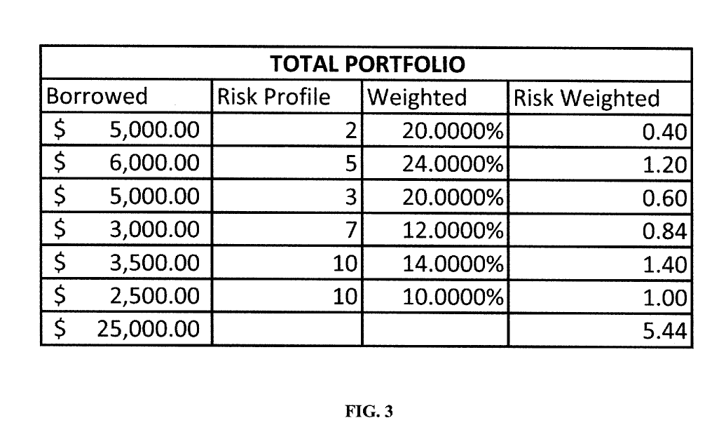

Turning now to the allocation and reallocation module 126, such may be configured to allocate loans or portions of loans to investors so as to account for the amount invested by each investor and to account for the risk profile established by the investor. As shown in FIG. 3, for example, the system may include a series of loans at any given time and the combined values of the loans may define a total portfolio amount. Each loan may be assigned a risk value as discussed above with respect to the borrower profile module. As shown, each loan may have a risk value where 1 may reflect low risk and 10 may reflect high risk. In the present example, there are six loans in the portfolio totaling $25,000 and their respective risk values are as shown. For purposes of allocation and reallocation, the system may apply a weight to each loan based on the risk value and the portion of the portfolio made up by the loan. As shown, for example, loan 1 includes a $5000 loan with a risk value of 2. The total of loans in the portfolio is $25,000, so loan 1 makes up 20% of the total portfolio and the weighted risk of the loan is 0.40 (i.e., 2×20% or 0.2=0.40). A weighted risk of each loan may be calculated for each loan in the portfolio and the sum of those weighted risks may provide a sense for the riskiness of the portfolio as a whole.

In some embodiments, limits may be put on the system such that a reasonable balance of risky loans and non-risky loans may be available for allocation to investors. For example, the system may limit the total weighted risk of the portfolio to a range of 1 to 9, or 2 to 8, or 3-7, or 4 to 6, or 4.5 to 5.5, for example. Still other ranges of weighted risk may be selected to provide a desired balance of loan types available for allocation. In still other embodiments, the system may be characterized as a higher risk higher return system and may use a range of weighted risk of 4-8, for example, or some other range of risk skewed toward more risky higher return loans. In still other embodiments, the system may be characterized as a lower risk lower return system and may use a range of weighted risk of 2-6, for example, or some other range of risk skewed toward less risky lower return loans.

It is to be appreciated that the loan values and the risks associated with those loans may change from time to time and the allocation module may accommodate such values and risks as it receives them from time to time depending on when the allocation module is triggered to allocate and/or reallocate. In some embodiments, the system may be set up as a cash flow system for investors where the principal and interest is paid to the investors as it is received. In other embodiments, however, the system may be set up as an ongoing investment where principal and interest received on one or more loans gets reinvested according to the risk level desired by the lender. It is noted, however, that in some cases, blocks may be placed on the system to prevent reallocation or transfer of loans that are known to be in bad standing. Limits of bad standing may be established and implemented accordingly.

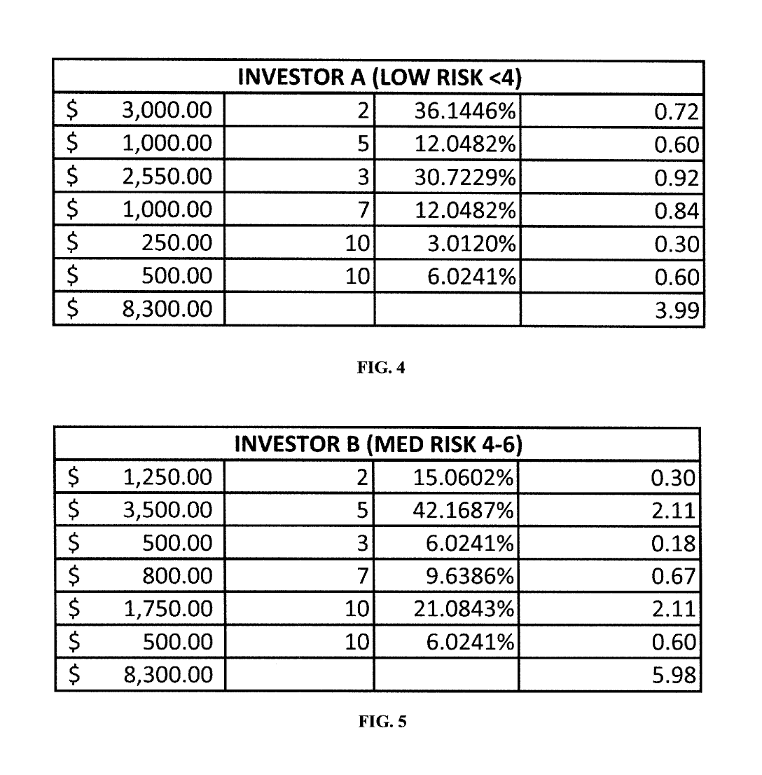

Turning now to FIGS. 4-6, the allocation of the six loans to three investors is shown. In the present example, each investor has invested approximately equal thirds of the total portfolio amount and portions of the loans have been allocated to each investor to arrive at each investor's desired risk profile. As shown in FIG. 4, for example, portions of loans 1 through 6 have been allocated to investor A as follows: $3000 of loan 1; $1000 of loan 2; $2550 of loan 3; $1000 of loan 4; $250 of loan 5; and $500 of loan 6. As may be appreciated, since investor A's risk tolerance is low (i.e., <4), small portions of high risk loans 5 and 6 have been allocated to investor A, but larger portions of low risk loans 1 and 3 have been allocated to investor A as well. More specifically, the amount of allocation of each loan may make up a portion of each investor's portfolio. That is, for example, the $3000 allocation of loan 1 to investor A may make up approximately 36% of investor A's total investment. The risk value of each loan may be multiplied by the portion of the loan relative to the investor's portfolio to determine the weighted risk of each loan relative to the investor's portfolio. That is, for example, for loan 1, risk value 2 multiplied by 36% provides a weighted risk of 0.72. The total of weighted risks for each loan may be summed to arrive at the risk value of each investor's portfolio. As shown, the weighted risk of investor A's portfolio is 3.99, which is within investor A's risk tolerance of <4.

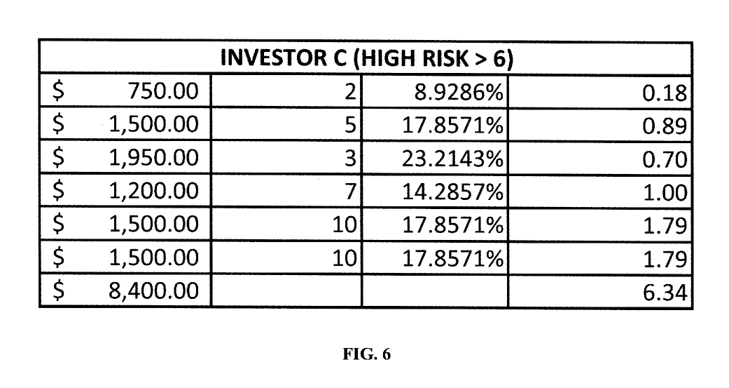

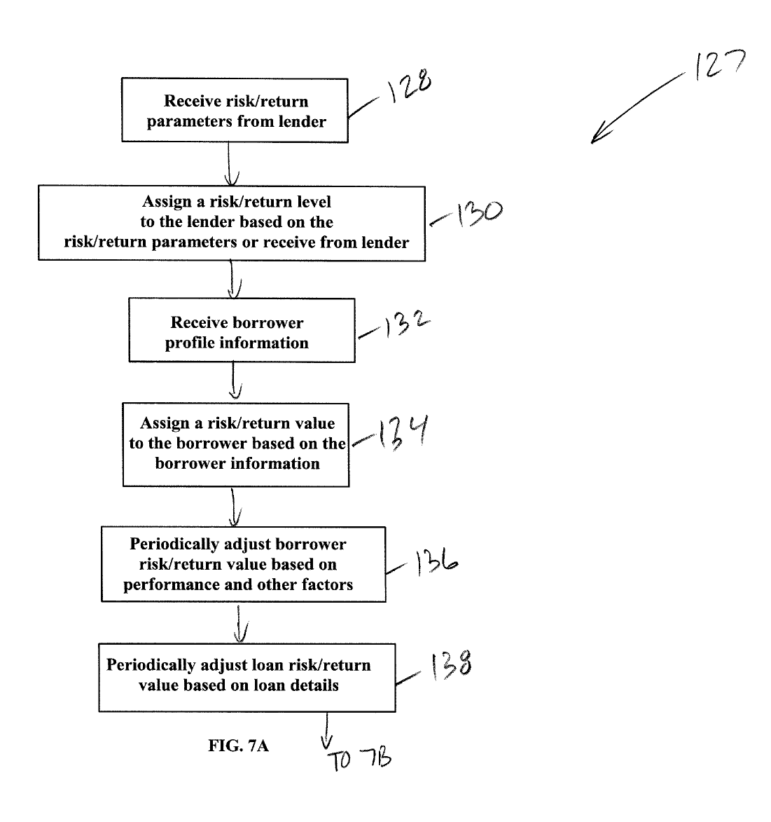

Similar allocations of the loan values may be allocated to investors B and C as shown in FIGS. 5-6 such that the total of all loan values in the portfolio (i.e., $25,000) are allocated to investors A, B, and C. Moreover, such allocation may be made to accommodate each investor's risk tolerance. As shown, investor B may have a medium risk tolerance of 4-6 and the weighted risk of the allocation of loans to investor B may be 5.98. Similarly, investor C may have a high risk tolerance of >6 and the weighted risk of the allocations of loans to investor C may be 6.34.

As may be appreciated, with time, circumstances of loans, borrowers, and other factors, the risk/return profile of a lender's investment portfolio may change. For example, as borrowers perform within the system, their performance may begin to affect the risk value associated with one or more of the borrowers loans. That is, while a credit score may be used initially to establish a risk value for a borrower, good or bad performance within the system may cause the risk value to decrease or increase, respectively. In some embodiments, for example, where a borrower misses a payment deadline, his risk value may be increased by 1 or 2 points, for example. In some embodiments, if the borrower makes the payment within 15 days after the deadline, the risk value may be adjusted by 1 point and if the borrower makes the payment within 30 days after the deadline, the risk value may be increased by 2 points. If the borrower is delinquent by 60 days, the risk value may be adjusted by 5 points, for example. In these cases, the interest rates on the borrower's loan or loans may increase. In contrast, if a 5 year loan is paid off on a 2 year amortization, the risk value of the borrower may decrease and the interest rate on the borrower's loans may decrease. Similarly, if an open ended loan, like a credit card, is treated like a closed ended loan (i.e., borrower pays off balance every month), the borrowers risk value may decrease as well. In this manner, borrowers risk values may change more readily than current, relatively slow moving credit scores, and borrowers may have an incentive to perform well under the system such that they can reap the benefits of lower interest rates. Borrower risk values may be reviewed periodically such as quarterly, for example. The risk value may be adjusted based on recent activity within the system, but may review an aggregate of the borrower's activity within the system. In some embodiments, a look back window may be provided allowing borrowers the ability to shed the effects of poor performance after a particular period of time has passed.

In addition to borrower performance, with time, some loans may be paid in full. Still further, even before payment in full, when high-risk loans are nearing repayment, the risk of the loan and the long-term rate of return on the loan may begin to diminish. In still other cases, some loans may be provided with variable interest rates and the changing interest rate may affect the rate of return that a lender sees across his/her portfolio. In still other embodiments, the risk value of a loan may be adjusted based on the amortization of the loan. In light of these changing factors, the risk/return profile and the weighted risk of a lender's investment portfolio may change. The allocation and reallocation module may, thus, reallocate portions of loans to rebalance and/or maintain each investor's portfolio at the desired risk/return profile as the risks of values change.

It is to be appreciated that particular levels of variance may be deemed acceptable and adjustment may be deemed unnecessary in these situations. However, where the variance is outside acceptable amounts, an adjustment process may be performed to bring the lender's portfolio back into alignment with the lender's parameters. In other embodiments, the reallocation may be performed periodically or on a scheduled basis and variance from a risk/return profile between those periods may simply be recognized as acceptable.

In some embodiments, the system may regularly offer and capture new loans to new borrowers. For example, where a relatively high-risk loan has been paid in full or is approaching full repayment, the system may search for borrowers with similar borrower profiles in an effort to identify new loans that could be used to replace the paid or almost paid loan and, thus, maintain the system portfolio at a relatively consistent weighted risk.

In use, a lender user may access the lending system via an Internet browser on a personal computer, smartphone, or other device, for example. The lender may be prompted with a login screen to allow the lender to establish an account and allow for repeated secure access to the same. The lender may be presented with a main menu, for example, and may access the risk/return parameters screen or interface by selecting a button or other access tool for the same. At the risk/return parameter screen the lender user may input information defining the lender's desired risk and desired return as detailed above with respect to the investors' risk/return parameter module. As such, the lender risk/return parameter module may receive and store the risk/return parameters. In some embodiments, the risk/return parameter module may assign a risk/return level based on the parameters.

Similarly, a borrower may access the lending system via an Internet browser on a personal computer, smartphone, or other device, for example. The borrower may be prompted with a login screen to allow the lender to establish an account and allow for repeated access to the same. The borrower may be presented with a main menu, for example, and may access the borrower profile screen or interface by selecting a button or other access tool for the same. At the borrower profile screen the borrower user may input information defining the borrower's profile as detailed above with respect to the borrower's profile module. As such, the borrower profile module may receive and store the borrower profile information. In some embodiments, the borrower profile module may assign a risk/return level to the borrower based on the borrower information.

Each of the lender and the borrower may access the transaction module to make an investment or borrow funds, respectively. In some embodiments, the borrower may repeatedly borrow funds by swiping a credit card, for example. After completing one or more transactions, the system may be relatively hands off for the lender. That is, having filled out the risk/return parameters and having invested funds, the lender may rely on the system to periodically and automatically monitor and assess the debt portfolios of its lenders to determine if any debt portfolio is out of alignment with the intended risk/return parameters. When the debt portfolio of any particular lender is out of alignment with its respective risk/return parameters, the system may perform an adjustment to bring the debt portfolio back into alignment. In some embodiments, this adjustment may include obtaining additional loans to refill the debt portfolio. In other embodiments, this adjustment process may include reallocating loans or portions of loans between one or more lenders. Still other adjustment techniques may also be provided.

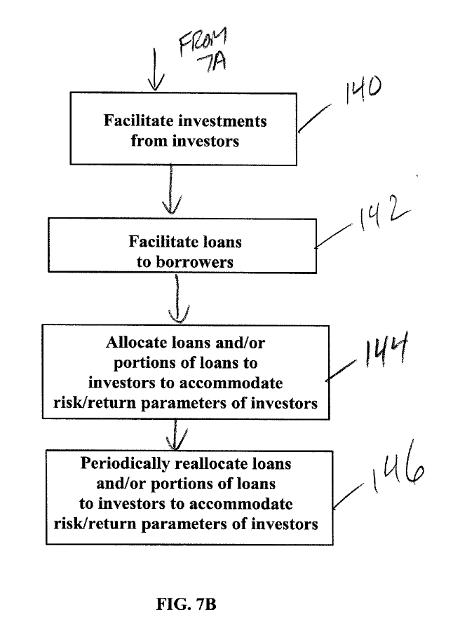

Referring to FIGS. 7A and 7B, a method 127 including a series of process steps is shown that may be performed by the system 100. It is to be appreciated that while show in flow chart form with flowing arrows, many and/or all of the steps may be performed in any order and are not limited to the order shown. In some embodiments, the system may receive risk/return parameters from a lender. (128) In some embodiments, such parameters may be received via the lender risk/return parameter module 122 discussed above. In some embodiments, having received the parameters, the system may assign a risk/return level to the lender based on those parameters. (130). In some embodiments, multiple profiles may be used for each lender and risk/return levels may be assigned to each profile. In some embodiments, lender risk/return parameters may not be used and the lender may directly enter or request a particular risk/return level for one or more profiles. The system may also receive borrower information. (132). This, for example, may occur via the borrower profile module 120 and associated interface. Based on this information, the system 100 may assign a risk/return value to a borrower or one or more existing or proposed loans of the borrower. (134). As discussed above, based on one or more different factors or circumstances, the system 100 may periodically adjust borrower risk/return values based on performance and other factors. (136). In addition, based on other factors or circumstances, the system may periodically adjust risk/return values based on loan details, such as approaching repayment or other amortization details. (138). The system 100 may also facilitate investment from investors or lenders. (140). For example, the transaction module 124 may allow an investor to supply funds to the system to be lent based on the lenders risk/return level or levels. Similarly, the system 100 may also facilitate loans to borrowers. (142). For example, the transaction module may fund a particular account of a borrower with funds from one or more investors and based on the borrower/loan risk/return value. The system may allocate loans and/or portions of loans to investors to accommodate the borrowed amount while also accommodating the risk/return levels of one or more investor profiles. (144). Periodically, the system may reallocate loans and/or portions of loans to investors to accommodate risk/return levels of investors and/or their various profiles. (146).

The concepts of the present disclosure may be advantageous for several reasons. For example, while similar to a peer-to-peer system, the several loans in the system may be allocated amongst several lenders so no single lender is subject to the actions of a single borrower. Moreover, the risk is not spread equally among the several lenders, but, instead is spread according to the risk tolerances of the particular lenders/investors. Accordingly, the system may be unlike common credit systems where one party (i.e., the bank) may be responsible for absorbing all of the risk of defaulting or poor performing borrowers. In those situations, the risk of poor performance may be pushed back to other borrowers in the form of high interest rates. In the present system, the risk is recognized by the investors/lenders and absorbed by such investors/lenders in exchange for higher interest rates to higher risk borrowers and lower interest rates for lower risk borrowers and without pushing it back to the other borrowers. As such, the interest rate on loans (even high risk loans) in the present system is expected to be less than other systems. For example, while a credit card may have an interest rate of 18-20%, the present system may allow for interest rates closer to 10%, on average, for example. Still further, the lenders/investors in the present system may take any amount of risk they are interested in taking and be provided with a return commensurate with that risk.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a personal computer (e.g., desktop or laptop), tablet computer, mobile device (e.g., personal digital assistant (PDA) or smart phone), server (e.g., blade server or rack server), a network storage device, or any other suitable device or combination of devices and may vary in size, shape, performance, functionality, and price. A system may include random access memory (RAM), one or more processing resources such as a central processing unit (CPU) or hardware or software control logic, ROM, and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A dynamic lending system, comprising:
a computing device in communication with a network, the computing device comprising:
a computer readable data storage medium having data structures stored thereon for facilitating and dynamically allocating peer-to-peer loan transactions, the data structures comprising:
a borrower profile module configured to receive borrower characteristics and assign a risk value;
a lender risk/return parameter module configured to establish a risk/return level of a lender;
a transaction module configured to facilitate investment by lenders and loans to borrowers; and
an allocation module configured to allocate loans or portions of loans to investors based on the risk value of loans and the risk/return level of the lender.

2. The dynamic lending system of claim 1, wherein the system periodically adjusts the risk value of a borrower.

3. The dynamic lending system of claim 2, wherein the system adjusts the risk value of a borrower based on performance of the borrower.

4. The dynamic lending system of claim 3, wherein the performance of the borrower includes consistent payments.

5. The dynamic lending system of claim 4, wherein the performance of the borrower includes payments by the borrower consistent with a closed-ended loan.

6. The dynamic lending system of claim 3, wherein the performance of the borrower is the performance of the borrower within the system.

7. The dynamic lending system of claim 1, wherein a risk/return level of a lender is attributed to a profile of the lender.

8. The dynamic lending system of claim 7, wherein the profile of the lender includes a plurality of profiles.

9. The dynamic lending system of claim 1, wherein the allocation module is further configured to reallocate loans or portions of loans periodically.

10. The dynamic lending system of claim 9, wherein reallocation is based on the existence of new loans within the system.

11. The dynamic lending system of claim 9, wherein reallocation is based on changes to the risk value of the borrower.

12. The dynamic lending system of claim 9, wherein the reallocation is based on receipt of payments of principal and interest.

13. The dynamic lending system of claim 9, wherein the reallocation is based on loans approaching repayment.

14. The dynamic lending system of claim 9, wherein the reallocation is based on an amortization schedule of one or more loans.

15. A method for dynamically facilitating peer-to-peer lending, comprising:
receiving borrower characteristics from a borrower to define a risk value for a loan;
establishing a risk/return level for a lender;
facilitating investment from a lender;
facilitating a loan to a borrower;
allocating a portion of the loan to the lender based on the risk/return level;
reallocating the portion of the loan attributable to the lender based on changing circumstances.

16. The method of claim 15, wherein the changing circumstances include a change in risk value.

17. The method of claim 16, wherein the changing circumstances are based on an amortization schedule of a loan.

18. The method of claim 17, wherein the changing circumstances include a loan approaching repayment in full.

19. The method of claim 15, wherein changing circumstances include receipt of principal and interest from a borrower.

20. The method of claim 19, wherein reallocating includes re-lending the principal and interest.
